(19) United States
(12) Patent Application Publication
(10) Pub. No.: US 2022/0342723 A1
(43) Pub. Date: Oct. 27, 2022

(54) FLOW RULE GENERATION DEVICE, FLOW RULE GENERATION METHOD AND NON-TRANSITORY COMPUTER-READABLE MEDIUM

(71) Applicant: FUJITSU LIMITED, Kawasaki-shi (JP)

(72) Inventor: Shogo Asaba, Kawasaki (JP)

(73) Assignee: FUJITSU LIMITED, Kawasaki-shi (JP)

(21) Appl. No.: 17/546,118

(22) Filed: Dec. 9, 2021

(30) Foreign Application Priority Data
Apr. 23, 2021 (JP) 2021-073023

(51) Int. Cl. G06F 9/54

(52) U.S. Cl. CPC G06F 9/54

(57) ABSTRACT

A flow rule generation device includes a memory, and a processor couped to the memory, the processor being configured to generate an adjacency matrix indicating containers having a relationship of a transmission source and a transmission destination of a packet among a plurality of containers, specify, from the adjacency matrix, a first container and a second container in which communication is expected to occur, among two of the containers in the adjacency matrix indicating that no communication in both directions exists, and add a rule that sets the first container as the transmission destination and the second container as the transmission source to information including another rule indicating a process to be performed on the packet according to the transmission source and the transmission destination of the packet.

### CROSS-REFERENCE TO RELATED APPLICATION

This application is based upon and claims the benefit of priority of the prior Japanese Patent Application No. 2021-073023 filed on Apr. 23, 2021, the entire contents of which are incorporated herein by reference.

### FIELD

A certain aspect of the embodiments is related to a flow rule generation device, a flow rule generation method and a non-transitory computer-readable medium.

### BACKGROUND

A container virtualization technology is a technology that achieves a virtual computer by using a part of the kernel of the host OS (Operating System), and has an advantage of being lighter than a VM (Virtual Machine) virtualization technology. A user space generated by the container virtualization technology is called a container.

With the development of such a container virtualization technology, a microservice architecture, in which a plurality of containers execute a plurality of application programs for achieving a service, respectively, is being widespread. As mentioned above, the containers are lightweight. Therefore, when a load on a single container in the microservice architecture increases, it is easy to scale out the container.

However, when the number of containers is increased in this way, new communication occurs between newly increased containers and existing containers, and communication delay between the containers may cause delay such as a service response time. Note that the technique related to the present disclosure is disclosed in International Publication Pamphlets No. WO2013/051386 and No. WO2014/098108.

### SUMMARY

According to an aspect of the present disclosure, there is provided a flow rule generation device including: a memory; and a processor couped to the memory, the processor being configured to: generate an adjacency matrix indicating containers having a relationship of a transmission source and a transmission destination of a packet among a plurality of containers; specify, from the adjacency matrix, a first container and a second container in which communication is expected to occur, among two of the containers in the adjacency matrix indicating that no communication in both directions exists; and add a rule that sets the first container as the transmission destination and the second container as the transmission source to information including another rule indicating a process to be performed on the packet according to the transmission source and the transmission destination of the packet.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a service achieved by a microservice architecture;

FIG. 2 is a configuration diagram of a system for achieving a service;

FIG. 3 is a schematic diagram of a virtual switch;

FIG. 4 is a schematic diagram of a flow rule;

FIGS. 5A and 5B are schematic diagrams of the service before and after adding a new container “B1”, respectively;

FIG. 6 is a configuration diagram of the system according to a first embodiment;

FIG. 7 is a configuration diagram of a physical server;

FIG. 8 is a schematic diagram for explaining a flow rule generation method according to the first embodiment;

FIGS. 9A to 9C are schematic diagrams for explaining a method of adding a rule in the first embodiment;

FIG. 10 is a functional configuration diagram of a flow rule generation device according to the first embodiment;

FIG. 11 is a flowchart of a flow rule generation method according to the first embodiment;

FIG. 12 is a schematic diagram for explaining the flow rule generation method according to a second embodiment;

FIGS. 13A and 13B are schematic diagrams for explaining the method of adding the rule in the second embodiment;

FIG. 14 is a flowchart of the flow rule generation method according to the second embodiment; and

FIG. 15 is a hardware configuration diagram of the physical server.

### DESCRIPTION OF EMBODIMENTS

It is an object of the present disclosure to suppress communication delay between containers.

Prior to the description of the present embodiment, matters studied by an inventor will be described.

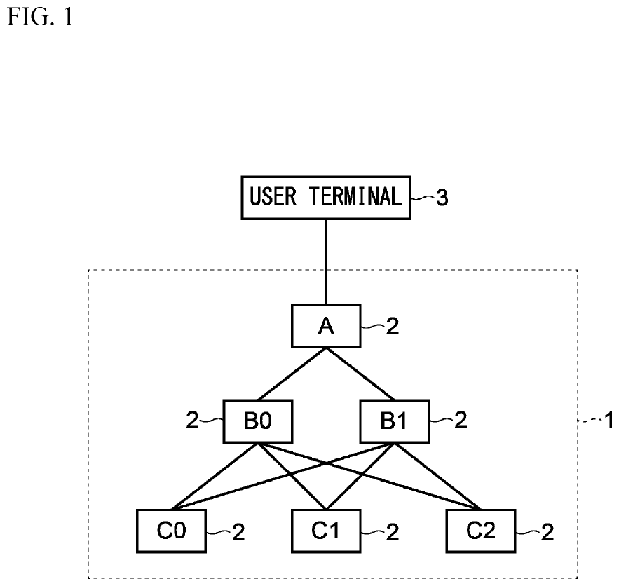

FIG. 1 is a schematic diagram of a service achieved by a microservice architecture.

As illustrated in FIG. 1, a service 1 is achieved by a plurality of containers 2, and performs various processes in response to a request from a user terminal 3 such as a PC (Personal Computer). Each of the containers 2 executes an application program for achieving a microservice obtained by dividing the service 1 for each function. In this example, it is assumed that one container 2 achieves one microservice and each of the containers 2 is identified by the name of the microservice such as “A” and “B0”.

Also, a straight line between two containers 2 indicates that communication from at least one of these containers 2 to the other exists. For example, the communication between the containers 2 that execute the microservices “A” and “B0” exists.

In this example, it is assumed that the microservices of “B0” and “B1” have the same function and the container 2 of “A” functions as a load balancer to distribute requests from the user terminal 3 to each of the containers 2 of “B0” and “B1”.

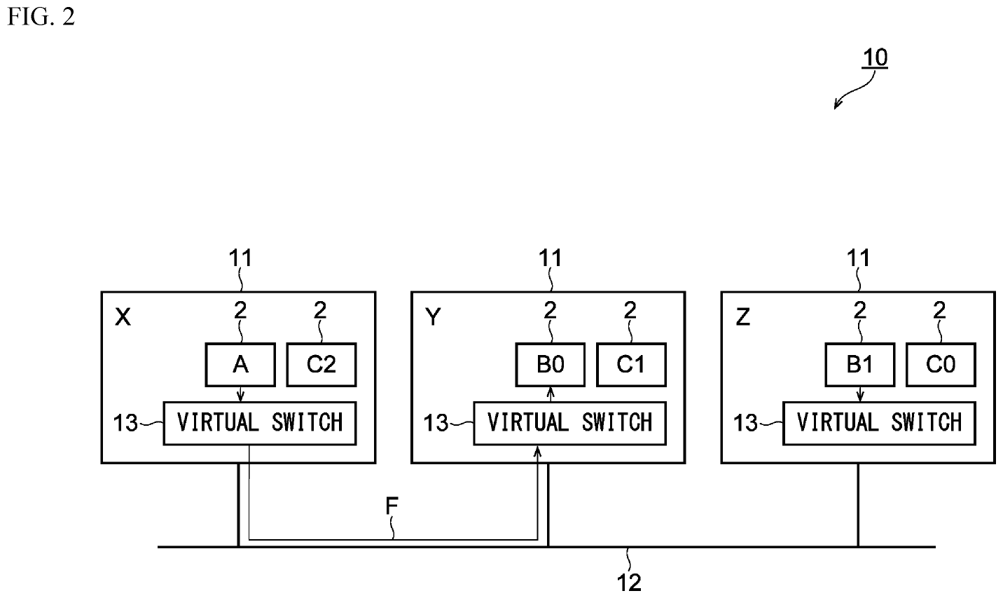

FIG. 2 is a configuration diagram of the system for achieving the service.

As illustrated in FIG. 2, a system 10 has a plurality of physical servers 11 that execute the containers 2 described above, and a network 12 such as the Internet or a LAN (Local Area Network) that connects these physical servers 11. A virtual server may be used instead of the physical server 11. Hereinafter, each of the plurality of physical servers 11 is identified by a character such as “X”, “Y”, or “Z”.

Further, each of the physical servers 11 executes a virtual switch 13 that connects each of the plurality of containers 2. For example, the container 2 of “A” executed by the physical server 11 of “X” and the container 2 of “B0” executed by the physical server 11 of “Y” are connected to each other by the virtual switch 13, as illustrated by an arrow F.

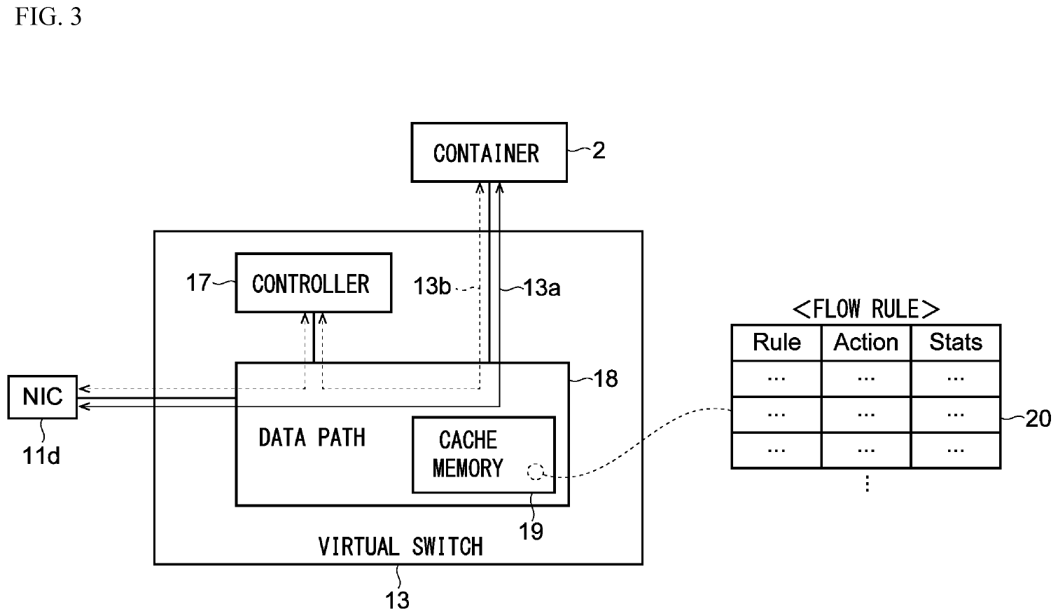

FIG. 3 is a schematic diagram of the virtual switch 13. As illustrated in FIG. 3, the virtual switch 13 includes a controller 17 and a data path 18.

The data path 18 is a processing unit that distributes packets received from a NIC (Network Interface Card) 11d of the physical server 11 to respective containers 2. For example, the data path 18 distributes the packets with reference to a flow rule 20 stored in its own cache memory 19.

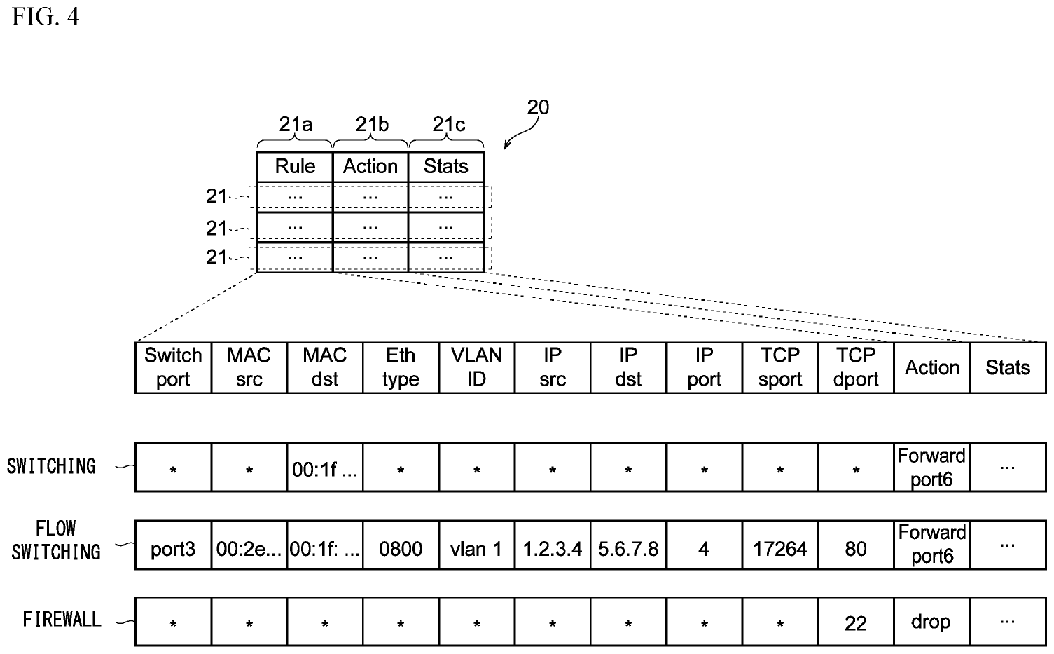

FIG. 4 is a schematic diagram of the flow rule 20. As illustrated in FIG. 4, the flow rule 20 is information including a plurality of rules 21. Each rule 21 is information including a process to be performed on the packet according to a transmission source and a transmission destination of the packet received by the virtual switch 13.

In this example, the rule 21 is information in which Rule21a, Action21b, and Stats21c are associated with each other. The Rule 21a indicates the transmission source and the transmission destination of the packet. For example, a pair of a transmission source MAC address “MAC src” and a transmission source IP address “IP src” is the transmission source of the packet. In addition, a pair of a transmission destination MAC address “MAC dst” and a transmission destination IP address “IP dst” is the transmission destination of the packet.

The Action 21b indicates a process that the virtual switch 13 performs on the packet when both of the transmission source and the transmission destination of the packet received by the virtual switch 13 match those in the Rule 21a.

Such a process includes switching, flow switching, and firewall, for example.

In the example of FIG. 4, when the “MAC dst” of the packet is “00:1f . . . ” and other transmission sources and transmission destinations are optional “*”, the switching is a process of forwarding the packet to a port number 6 with the MAC address “00:1f . . . ”.

The flow switching is a process of forwarding the packet that matches the Rule 21a to the port number 6 with the MAC address “00:1f . . . ”.

Then, the firewall is a process of discarding the packet with a TCP port number of 22.

Again, FIG. 3 is referred to. When the rule 21 that matches each of the transmission source and the transmission destination of the received packet exists in the flow rule 20, the data path 18 processes the packet according to the rule 21. Hereinafter, the existence of the rule 21 in the flow rule 20 that matches each of the transmission source and the transmission destination of the received packet is referred to as a cache hit.

On the other hand, when the flow rule 20 that matches each of the transmission source and the transmission destination of the received packet does not exist in the rule 21, the data path 18 inquires the controller 17 about the process for the packet. A fact that the rule 21 that matches the received packet does not exist in the flow rule 20 is called a cache miss. Further, the inquiry that the data path 18 makes to the controller 17 as described above when the cache miss occurs is called Upcall.

The controller 17 that receives the Upcall specifies the transmission source and the transmission destination of the received packet from the packet, further determines the process according to the transmission source and the transmission destination, and notifies the data path 18 of the process. The data path 18 that has received the notification adds the rule 21 indicated by the notified process to the flow rule 20, and performs on the packet the process based on the rule.

When the data path 18 receives a new packet whose transmission source and transmission destination do not exist in the existing flow rule 20 in this way, the data path 18 adds a new rule 21 corresponding to the transmission source and the transmission destination to the flow rule 20. Therefore, the Upcall occurs every time the transmission source and the transmission destination receive the new packet that does not exist in the existing flow rule 20.

Further, the packet received by the virtual switch 13 passes through different routes 13a and 13b inside the virtual switch 13 depending on whether the cache hit occurs or the cache miss occurs in this way. The route 13a is a route when the cache hit occurs, and the route 13b is a route when the cache miss occurs.

In the case of the cache hit, since the route 13a does not pass through the controller 17, the virtual switch 13 can process the packet at high speed. On the other hand, in the case of the cache miss, since the route 13b passes through the controller 17 by Upcall, a processing speed at which the virtual switch 13 processes the packet decreases.

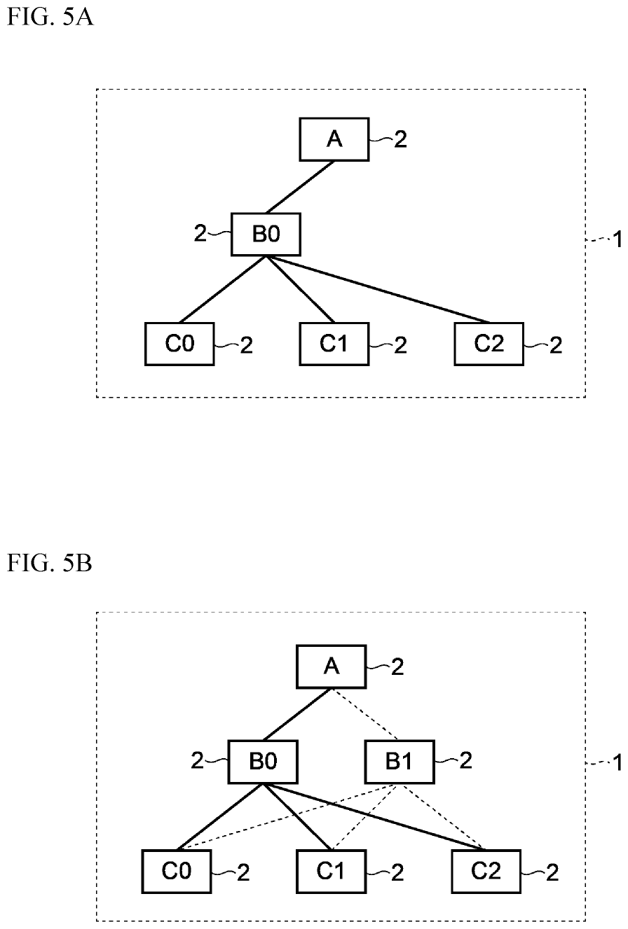

In particular, the delay associated with such an Upcall becomes remarkable in the service 1 that employs the microservice architecture. This will be described with reference to FIGS. 5A and 5B.

FIGS. 5A and 5B are schematic diagrams of the service 1 before and after adding the new container 2 of “B1”, respectively.

As illustrated in FIG. 5A, before the container 2 of “B1” is added, the communication illustrated by solid lines occurs between the respective containers 2.

At this time, for example, consider a case where the load of the container 2 of “B0” increases. In this case, in order to reduce the load on the container 2 of “B0”, the container 2 of “B1” having the same function as the container 2 of “B0” may be added to the service 1 as illustrated in FIG. 5B. As an example, a container management program KUBERNETES (registered trademark) may scale out the container 2 of “B0” to the container 2 of “B1”.

In this case, new communication indicated by the dotted line occurs. The rule 21 corresponding to the transmission source and the transmission destination of this communication does not exist in the flow rule 20 immediately after the container 2 of “B1” is added. Therefore, the Upcall occurs every time the communication indicated by the dotted line occurs, and the communication between the containers 2 inside the service 1 is greatly delayed. Hereinafter, each embodiment capable of suppressing such a delay will be described.

### First Embodiment

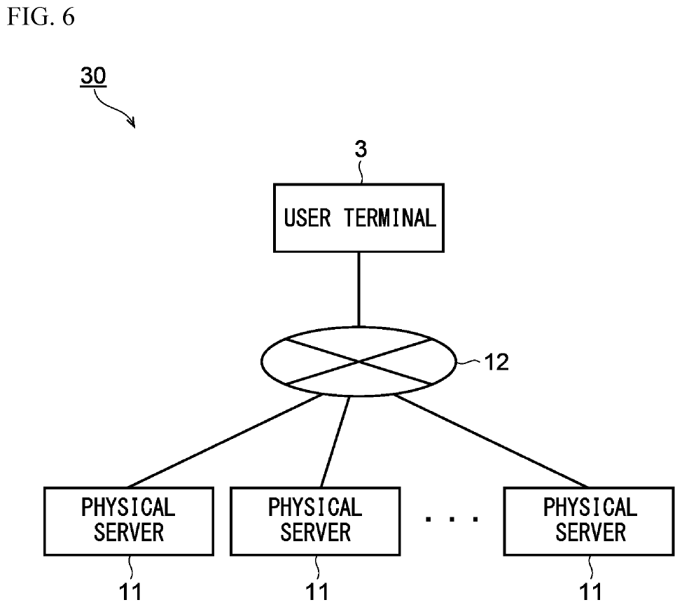

FIG. 6 is a configuration diagram of the system according to a first embodiment. In FIG. 6, the same elements as those described in FIGS. 1 to 5 are designated by the same reference numerals in these figures, and the description thereof will be omitted below.

A system 30 is a system for achieving the service 1 of FIG. 1, and has the physical servers 11 and the user terminal 3 connected to each other via the network 12. A virtual server may be used instead of each of the physical servers 11.

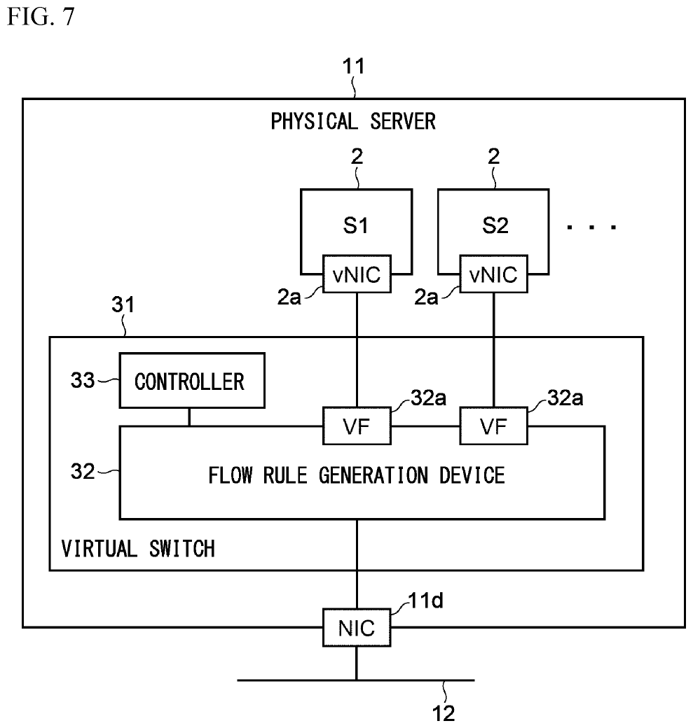

FIG. 7 is a configuration diagram of the physical server 11. As illustrated in FIG. 7, the physical server 11 is a computer that executes the container 2. Similar to the example of FIG. 1, in the present embodiment, it is assumed that one container 2 executes an application program for achieving one microservice, and each container 2 is identified by the name of the microservice such as “S1” and “S2”.

Further, the physical server 11 includes a virtual switch 31 for distributing the packets to the respective containers 2. The virtual switch 31 has a flow rule generation device 32 and a controller 33.

The flow rule generation device 32 is a data path, and a processing unit that performs the process on the packets received by the virtual switch 31 by referring to the flow rule 20 (see FIG. 4) stored in its own cache memory. The container 2 that is the transmission source and transmission destination of the packet may be executed by the same physical server 11, or one container 2 of the two physical servers 11 may be the transmission source and the container 2 of the other physical server 11 may be the transmission destination.

When the packets are transmitted and received across the plurality of physical servers 11 in this way, the flow rule generation device 32 transmits and receives the packets to/from the NICs 11d of the physical servers 11.

Further, the flow rule generation device 32 includes a virtual port 32a for communicating with the container 2 executed by the physical server 11. The virtual port 32a is a virtual interface connected to the virtual NIC 2a of each container 2, and is also called a VF (Virtual Function) port.

Further, the flow rule generation device 32 requests the controller 33 to determine the process to be performed on the packet when the above-mentioned Upcall occurs.

When the controller 33 receives the request from the flow rule generation device 32, the controller 33 determines the process to be performed on the packet received by the virtual switch 31 and notifies the flow rule generation device 32 of the process.

Next, a flow rule generation method to be performed by the flow rule generation device 32 will be described.

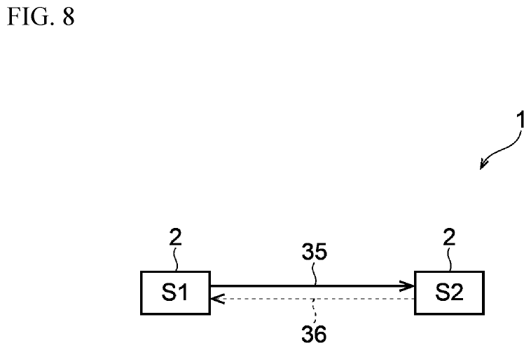

FIG. 8 is a schematic diagram for explaining the flow rule generation method according to the present embodiment.

In FIG. 8, it is assumed that the service 1 is achieved by each of the containers 2 of “S1” and “S2”. It is also assumed that communication 35 from the container 2 of “S1” to the container 2 of “S2” actually exists, but communication 36 from the container 2 of “S2” to the container 2 of “S1” does not yet exist. The container 2 of “S1” is an example of a first container, and the container 2 of “S2” is an example of a second container.

In this case, the flow rule 20 has the rule 21 in which the container 2 of “S1” is the transmission source and the container 2 of “S2” is the transmission destination. However, since the communication 36 in the opposite direction to the communication 35 does not exist, the rule 21 having the container 2 of “S1” as the transmission destination and the container 2 of “S2” as the transmission source does not exist in the flow rule 20.

Even when communication in both directions does not exist in this way, if communication 35 in one direction already exists, it is expected that communication 36 in the opposite direction will occur in the future.

Therefore, the flow rule generation device 32 adds the rule 21 related to the communication 36 to the flow rule 20 as follows.

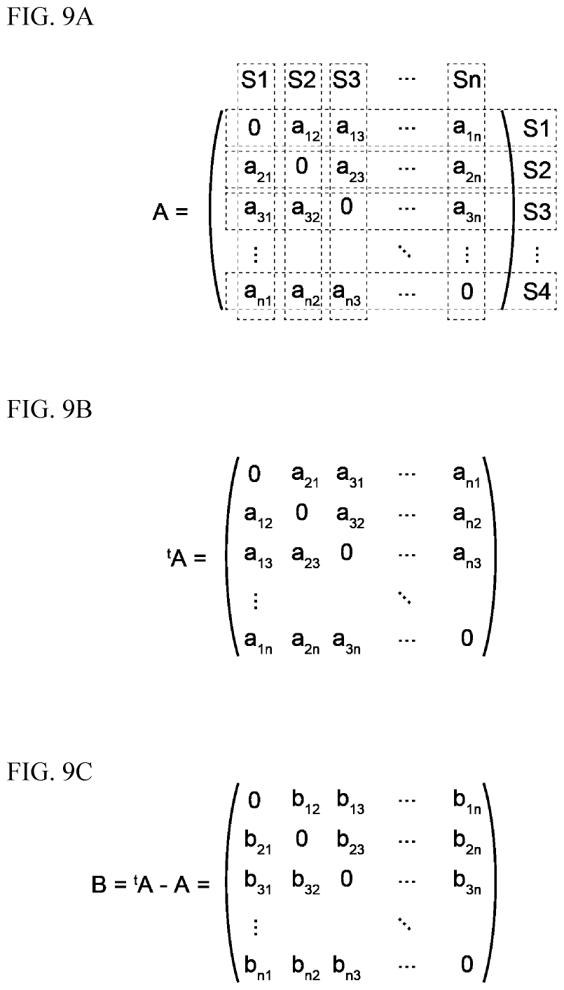

FIGS. 9A to 9C are schematic diagrams for explaining a method of adding the rule 21.

First, the flow rule generation device 32 generates an adjacency matrix A illustrated in FIG. 9A. The adjacency matrix A is a matrix indicating two containers 2 having a relationship of the transmission source and the transmission destination of the packet. When there are n containers 2 of “S1”, “S2”, . . . “Sn” which achieve the service 1, the adjacency matrix A is a square matrix with n rows and n columns. A line number i of an element aᵢⱼ in the adjacency matrix A corresponds to the container 2 of the transmission source “Sj”. Similarly, a column number j of the element aᵢⱼ corresponds to the container 2 of the transmission destination “Sj”.

A value of the element aij is “1” when the communication in which the container 2 of “Si” is the transmission source and the container 2 of “Sj” is the transmission destination exists, and it is “0” when such a communication does not exist.

For example, the flow rule generation device 32 specifies the transmission source and the transmission destination from each rule 21 in the current flow rule 20, and generates the adjacency matrix A based on the specified transmission source and the specified transmission destination.

Next, as illustrated in FIG. 9B, the flow rule generation device 32 generates a transposed matrix ^{t}A of the adjacency matrix A.

Subsequently, as illustrated in FIG. 9C, the flow rule generation device 32 calculates a matrix B corresponding to a difference (^{t}A-A) between the transposed matrix ^{t}A and the adjacency matrix A.

A value of the element bᵢⱼ in the matrix B is “0” when no communication in neither one direction nor both directions between each container 2 of “Si” and “Sj” exists. The value of the element bᵢⱼ is also “0” when the communication in both directions between the respective containers 2 of “Si” and “Sj” exists.

On the other hand, if the communication in which the container 2 of “Sj” is the transmission source and the container 2 of “Si” is the transmission destination exists, and no communication in which the container 2 of “Sj” is the transmission destination and the container 2 of “Si” is the transmission source exists, the value of the element bᵢⱼ is “−1”.

If the communication in which the container 2 of “Sj” is the transmission destination and the container 2 of “Si” is the transmission source exists, and no communication in which the container 2 of “Sj” is the transmission source and the container 2 of “Si” is the transmission destination exists, the value of the element bᵢⱼ is “1”.

Based on the above, the flow rule generation device 32 specifies the container 2 of “Sj” of the transmission destination and the container 2 of “Si” of the transmission source by specifying the element bᵢⱼ whose value is “1” in the matrix B.

Then, the flow rule generation device 32 adds, to the flow rule 20, the rule 21 relating to communication in which the container 2 of “Sj” is the transmission source and the container 2 of “Si” is the transmission destination.

Thereby, before the communication in which the container 2 of “Sj” is the transmission source and the container 2 of “Si” is the transmission destination actually occurs, the rule 21 of the communication exists in the flow rule 20. Therefore, it is possible to suppress the occurrence of the Upcall caused by the communication from “Sj” to “Si”, and to suppress the occurrence of the delay caused by the Upcall in the service employing the microservice architecture.

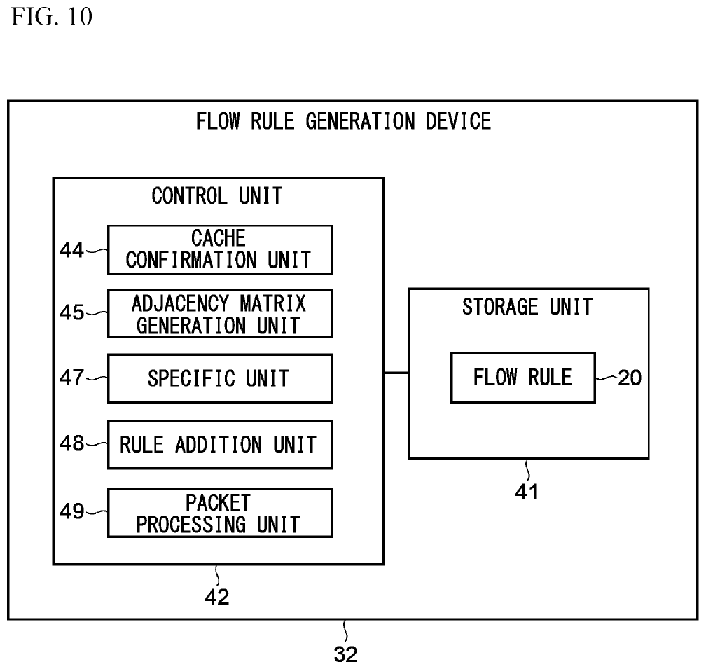

FIG. 10 is a functional configuration diagram of the flow rule generation device 32 according to the present embodiment.

As illustrated in FIG. 10, the flow rule generation device 32 includes a storage unit 41 and a control unit 42.

The storage unit 41 is a processing unit for achieving the cache memory, and stores the flow rule 20 described in FIG. 4.

On the other hand, the control unit 42 is a processing unit that controls each unit in the flow rule generation device 32. As an example, the control unit 42 includes a cache confirmation unit 44, an adjacency matrix generation unit 45, a specific unit 47, a rule addition unit 48, and a packet processing unit 49.

The cache confirmation unit 44 is a processing unit that confirms whether the number of rules 21 in the flow rule 20 increases from the previous confirmation by referring to the storage unit 41 which is the cache memory.

The adjacency matrix generation unit 45 is a processing unit that generates the above-mentioned adjacency matrix A (see FIG. 9A).

The specific unit 47 is a processing unit that specifies from the adjacency matrix A two containers 2 that are expected to generate communication in the future among a plurality of combinations of two containers 2 in which the communication in both directions does not exist in the adjacency matrix A. As an example, the specific unit 47 specifies the element bij having a value of “1” in the matrix B of the difference between the adjacency matrix A and its transposed matrix to predict that the communication in which the container 2 of “Si” is the transmission destination and the container 2 of “Sj” is the transmission source will occur in the future.

The rule addition unit 48 is a processing unit that adds, to the flow rule 20, the rule 21 related to the communication between the two containers 2 specified by the specific unit 47. In the above example, the rule addition unit 48 adds, to the flow rule 20, the rule 21 relating to the communication in which the container 2 of “Si” is the transmission destination and the container 2 of “Sj” is the transmission source.

Further, the rule addition unit 48 performs the Upcall to the controller 33 when a cache error occurs in which the rule 21 corresponding to the transmission source and the transmission destination of the packet received by the virtual switch 31 does not exist in the flow rule 20. Then, the rule addition unit 48 adds the rule 21 generated by the controller 33 in Upcall to the flow rule 20.

The packet processing unit 49 is a processing unit that specifies the rule 21 corresponding to the transmission source and the transmission destination of the packet received by the virtual switch 31 from the flow rule 20, and performs on the packet the process indicated by the rule 21.

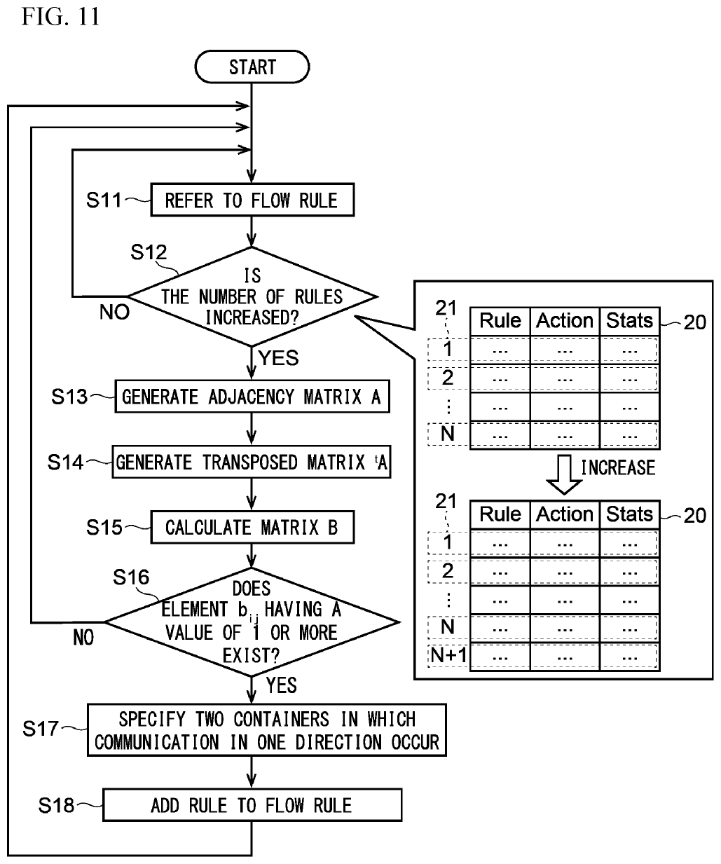

FIG. 11 is a flowchart of the flow rule generation method according to the present embodiment.

First, the cache confirmation unit 44 refers to the flow rule 20 (step S11), and determines whether the number of rules 21 in the flow rule 20 is increased from the previous confirmation (step S12).

For example, if the number of rules 21 is N at the time of the previous confirmation and the number of rules 21 is N+1 at the time of current confirmation, the cache confirmation unit 44 determines that the number of rules 21 is increased.

Here, when the number of rules 21 is not increased (NO in step S12), the procedure returns to step S11.

On the other hand, when the number of rules 21 is increased (YES in step S12), the procedure proceeds to step S13. When the number of rules is increased, it is considered that the UpCall occurs because the new container 2 is added to the service as described above and unprecedented communication occurs in the service.

Therefore, the control unit 42 performs the following process in order to prevent the communication of the service from being delayed due to the further occurrence of the Upcall.

First, in step S13, the adjacency matrix generation unit 45 generates the adjacency matrix A.

Next, the specific unit 47 generates the transposed matrix ^{t}A of the adjacency matrix A (step S14).

Subsequently, the specific unit 47 calculates the matrix B corresponding to the difference (^{t}A-A) between the adjacency matrix A and the transposed matrix to (step S15).

Next, the specific unit 47 determines whether an element having a value of “1” or more exists among the elements bᵢⱼ of the matrix B (step S16). As described above, the value of the element bij is “1” when a communication in which the container 2 of “Sj” is the transmission destination and the container 2 of “Si” is the transmission source exists, and no communication in which the container 2 of “Sj” is the transmission source and the container 2 of “Si” is the transmission destination exists.

Therefore, the judgment of step S16 is YES only when the communication in one direction from “Si” to “Sj” actually exists.

Here, if the determination in step S16 is NO, the procedure returns to step S11. On the other hand, if the determination in step S16 is YES, the procedure proceeds to step S17.

In step S17, the specific unit 47 specifies two containers 2 in which the communication in both directions does not occur and the only communication in one direction actually occurs, based on the element bᵢⱼ. As an example, the specific unit 47 specifies “Si” corresponding to the row number i of the element bij having the value of “1” or more as the container 2 of the transmission source, and “Sj” corresponding to the column number j as the container 2 of the transmission destination.

In this case, as described with reference to FIG. 8, there is a high possibility that communication from the container 2 of “Sj” to the container 2 of “Si” will occur in the future.

Therefore, the rule addition unit 48 adds the rule 21 relating to the communication in which the container 2 of “Sj” is the transmission source and the container 2 of “Si” is the transmission destination to the flow rule 20 (step S18). Then, the procedure returns to step S11.

This completes the basic process of the flow rule generation method according to the present embodiment.

According to the present embodiment described above, in step S17, the specific unit 47 specifies the containers 2 of “Si” and “Sj”, which are expected to generate the communication in the future, among the two containers 2 in which the communication in only one direction occurs in the adjacency matrix A. Then, in step S18, the rule addition unit 48 adds the rule 21 related to the communication from “Sj” to “Si” to the flow rule 20.

Therefore, before the communication from “Sj” to “Si” actually occurs, the rule 21 related to the communication exists in the flow rule 20. As a result, it is possible to suppress the occurrence of the Upcall when the communication from “Sj” to “Si” occurs, and suppress the communication delay of the service achieved in the containers 2 of “S1” to “Sn”.

### Second Embodiment

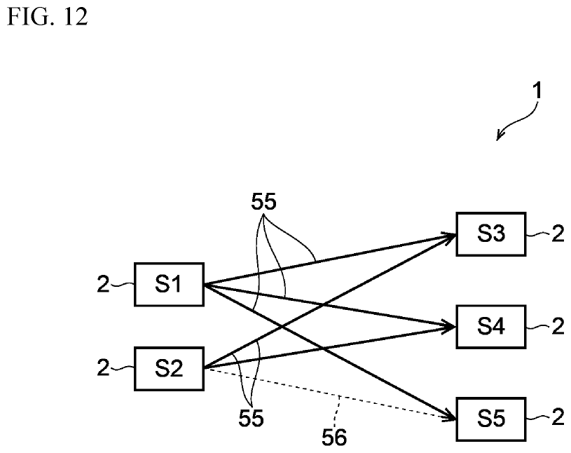

FIG. 12 is a schematic diagram for explaining the flow rule generation method according to a second embodiment. In FIG. 12, the same elements as those described in the first embodiment are designated by the same reference numerals in the first embodiment, and the description thereof will be omitted below.

In FIG. 12, it is assumed that the service 1 is achieved by the respective containers 2 of “S1” to “S5”.

Further, it is assumed that the communication in which the container 2 of “S1” is the transmission source and the containers 2 of “S3” to “S5” are the transmission destination actually exists, and the communication in which the container 2 of “S2” is the transmission source and the containers 2 of “S3” and “S4” are the transmission destination actually exists, as indicated by communication 55 of solid lines.

However, it is assumed that the communication in which the container 2 of “S2” is the transmission source and the container 2 of “S5” is the transmission destination does not exist at this point, as indicated by communication 56 of a dotted line.

In this case, the rule 21 corresponding to the communication 55 exists in the flow rule 20 (see FIG. 4), but the rule 21 corresponding to the communication 56 does not exist in the flow rule 20.

Even if the communication 56 does not actually exist in this way, when the containers 2 of “S1” and “S2” are similar to each other, the communication 56 may occur in the future. For example, consider a case where the microservices of “S1” and “S2” are the same as each other and their functions are the same as each other. In this case, when the communication 55 from the container 2 of “S1” to the container of “S5” exists, there is a high possibility that the communication 56 from the container 2 of “S2” having the same function as “S1” to the container of “S5” will occur in the future.

Therefore, the specific unit 47 determines whether the two containers 2 are similar as each other as follows, and adds the rule 21 to the flow rule 20 if they are similar.

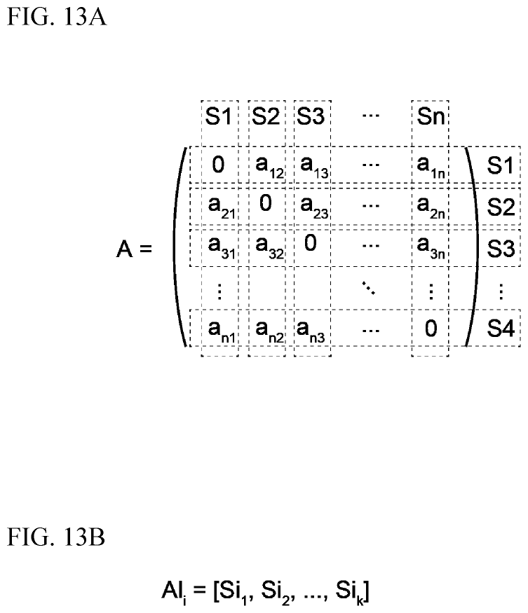

FIGS. 13A and 13B are schematic diagrams for explaining the method of adding the rule 21.

First, the adjacency matrix generation unit 45 generates the adjacency matrix A in the same manner as in the first embodiment, as illustrated in FIG. 13A.

Next, the specific unit 47 generates an adjacency list Alᵢ=[Si₁, Si₂, . . . , Siₖ] of the container 2 of “Si” (1≤i≤n) based on the adjacency matrix A, as illustrated in FIG. 13B. The adjacency list Alᵢ is a list whose element is the container 2 that communicates with the container 2 of “Si”. As an example, the specific unit 47 specifies the container 2 of “Siₘ” that communicates with the container 2 of “Si” by identifying a column number m having a value of “1” in an i-th row of the adjacency matrix A, and adds the container 2 of “Siₘ” to the adjacency list Ali.

In the example of FIG. 12, the adjacency list of the container 2 of “S1” is [S3, S4, S5], and the adjacency list of the container 2 of “S2” is [S3, S4]. The container 2 of “S2” is an example of the first container, the container 2 of “S5” is an example of the second container, and the container 2 of “S1” is an example of a third container.

The adjacency list [S3, S4] is an example of a first list, and the adjacency list [S3, S4, S5] is an example of a second list.

Next, the specific unit 47 selects any two adjacency lists Alₚ and Al_{q} from the plurality of adjacency lists Alᵢ (1≤i≤n). Then, when the number of elements commonly included in these adjacency lists Alₚ and Al_{q} is equal to or more than a predetermined threshold value M, the specific unit 47 determines that the container 2 of “Sp” and the container 2 of “Sq” are similar as each other.

In the example of FIG. 12, since there are two elements “S3” and “S4” common to the adjacency list [S3, S4, S5] and the adjacency list [S3, S4], the containers 2 of “S1” and “S2” are similar to each other by setting the threshold value M to “2”. The threshold value M is not particularly limited and can be set voluntarily.

Next, the specific unit 47 specifies an element included in the adjacency list Alₚ but not in the adjacency list Al_{q}, among the adjacency list Alₚ and Al_{q} corresponding to the containers 2 of the similar “Sp” and “Sq”.

In the example of FIG. 12, since the container 2 of “S5” is included in the adjacency list [S3, S4, S5] but is not included in the adjacency list [S3, S4], the specific unit 47 specifies the container 2 of “S5”.

Thus, since the container 2 of “S5” is not included in the adjacency list [S3, S4] of the container 2 of “S2”, no communication between the containers 2 of “S2” and “S5” occurs at current time. However, since the communication actually occurs between the container 2 of “S1” similar to “S2” and the container of “S5” as mentioned above, the communication may occur between “S2” and “S5” in the future.

Therefore, the rule addition unit 48 adds, to the flow rule 20, the rule 21 in which the container 2 of “Sq” is the transmission source and the container 2 that is included in the adjacency list Alₚ but not included in the adjacency list Al_{q} is the transmission destination. In the example of FIG. 12, the rule 21 in which the container 2 of “S2” is the transmission source and the container 2 of “S5” is the transmission destination is added.

Thereby, even if the communication from “S2” to “S5” occurs in the future, the Upcall does not occur because the rule 21 related to the communication exists in the flow rule 20, and the occurrence of the delay in communication between the containers 2 can be suppressed.

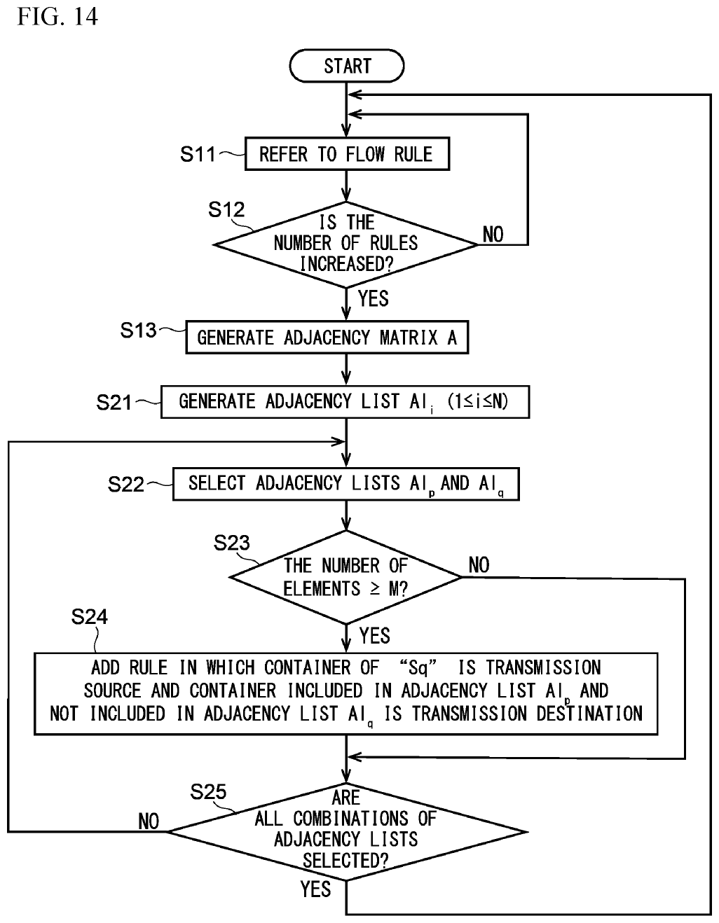

FIG. 14 is a flowchart of the flow rule generation method according to the present embodiment. In FIG. 14, the same elements as those described in FIG. 11 are designated by the same reference numerals in FIG. 11, and the description thereof will be omitted below.

First, the cache confirmation unit 44 refers to the flow rule 20 (step S11), and determines whether the number of rules 21 in the flow rule 20 is increased from the previous confirmation (step S12).

Here, if the number of rules 21 is not increased (NO in step S12), the procedure returns to step S11.

On the other hand, if the number of rules 21 is increased (YES in step S12), the procedure proceeds to step S13, and the adjacency matrix generation unit 45 generates the adjacency matrix A.

Next, the specific unit 47 generates the adjacency list Alᵢ=[Si₁, Si₂, . . . , Siₖ] of the container 2 of “Si” (1≤i≤n) based on the adjacency matrix A (Step S21).

Next, the specific unit 47 selects any two adjacency lists Alₚ and Al_{q} from the plurality of adjacency lists Alᵢ (1≤i≤n) (step S22).

Subsequently, the specific unit 47 determines whether the number of elements commonly included in the adjacency lists Alₚ and Al_{q} is the threshold value M or more (step S23).

Here, when the number of elements is the threshold value M or more (YES in step S23), the container 2 of “Sp” and the container 2 of “Sq” are similar to each other as described above. Therefore, in this case, the rule addition unit 48 adds, to the flow rule 20, the rule 21 related to the communication, which is highly likely to occur in the future, in which the container 2 of “Sq” is the transmission source (step S24). The rule 21 is communication in which the container 2 of “Sq” is the transmission source and the container 2 included in the adjacency list Alₚ and not included in the adjacency list Al_{q} is the transmission destination.

Next, the specific unit 47 determines whether all the combinations of the adjacency lists are selected (step S25). Even if the determination in step S23 is NO, step S24 is skipped and step S25 is executed.

Then, when all the combinations of the adjacency lists are selected (YES in step S25), the procedure returns to step S11. On the other hand, when all the combinations of the adjacency lists are not selected (NO in step S25), the procedure returns to step S22 and an unselected adjacency list is selected.

This completes the basic process of the flow rule generation method according to the present embodiment.

According to the present embodiment described above, in step S24, the rule addition unit 48 adds the rule 21 related to the communication that may occur in the future to the flow rule 20. The rule 21 is communication in which the container 2 of “Sq” is the transmission source and the container 2 included in the adjacency list Alₚ and not included in the adjacency list Al_{q} is the transmission destination. Thereby, the rule 21 exists in the flow rule 20 before the communication actually occurs, so that it is possible to suppress the occurrence of the delay in communication of the service caused by the Upcall.

### (Hardware Configuration)

Next, the hardware configuration of the flow rule generation device 32 according to the first and second embodiments will be described.

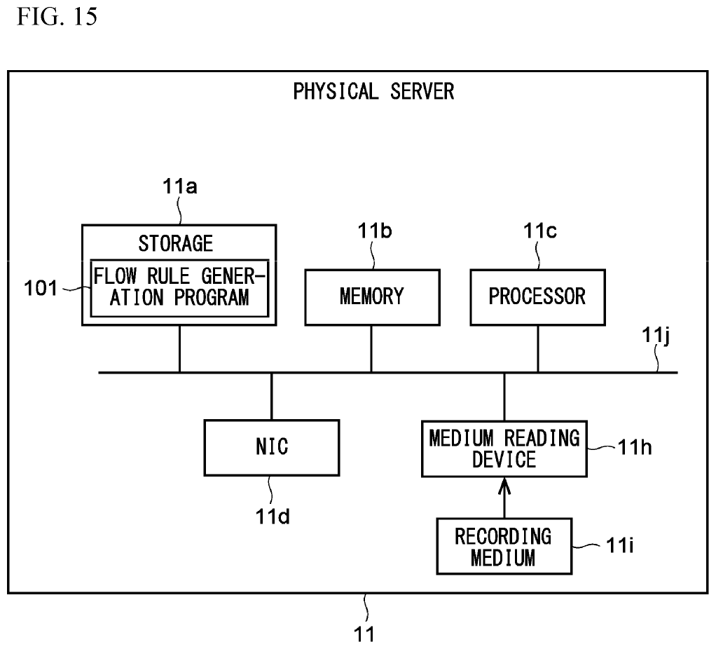

FIG. 15 is a hardware configuration diagram of the physical server 11. As illustrated in FIG. 15, the physical server 11 includes a storage 11a, a memory 11b, a processor 11c, a NIC 11d and a medium reading device 11h. These elements are connected to each other by a bus 11j.

The storage 11a is a non-volatile storage such as an HDD (Hard Disk Drive) or an SSD (Solid State Drive), and stores a flow rule generation program 101 according to the present embodiment.

The flow rule generation program 101 may be recorded on a computer-readable recording medium 11i, and the processor 11c may be made to read the flow rule generation program 101 via the medium reading device 11h.

Examples of such a recording medium 11i include physically portable recording media such as a CD-ROM (Compact Disc-Read Only Memory), a DVD (Digital Versatile Disc), and a USB (Universal Serial Bus) memory. Further, a semiconductor memory such as a flash memory, or a hard disk drive may be used as the recording medium 11i. The recording medium 11i is a computer-readable media, and is not a temporary medium such as a carrier wave having no physical form.

Further, the flow rule generation program 101 may be stored in a device connected to a public line, the Internet, a LAN (Local Area Network), or the like. In this case, the processor 11c may read and execute the flow rule generation program 101.

Meanwhile, the memory 11b is hardware that temporarily stores data, such as a DRAM (Dynamic Random Access Memory).

The processor 11c is hardware such as a CPU and a GPU (Graphical Processing Unit) that control each part of the physical server 11. Further, the processor 11c executes the flow rule generation program 101 in cooperation with the memory 11b.

In this way, the memory 11b and the processor 11c cooperate to execute the flow rule generation program 101, which can achieve the control unit 42 of the flow rule generation device 32 (see FIG. 10).

Further, the storage unit 41 of the flow rule generation device 32 (see FIG. 10) is achieved by the storage 11a and the memory 11b.

The NIC 11d is hardware for connecting the physical server 11 to the network 12 (see FIG. 6).

The medium reading device 11h is hardware such as a CD drive, a DVD drive, and a USB interface for reading the recording medium 11i.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A flow rule generation device comprising:
a memory; and
a processor couped to the memory, the processor being configured to:
generate an adjacency matrix indicating containers having a relationship of a transmission source and a transmission destination of a packet among a plurality of containers;
specify, from the adjacency matrix, a first container and a second container in which communication is expected to occur, among two of the containers in the adjacency matrix indicating that no communication in both directions exists; and
add a rule that sets the first container as the transmission destination and the second container as the transmission source to information including another rule indicating a process to be performed on the packet according to the transmission source and the transmission destination of the packet.

2. The flow rule generation device as claimed in claim 1, wherein
the to specify a first container and a second container includes to specify the container of the transmission destination as the second container and specifies the container of the transmission source as the first container, among the two of the containers in the adjacency matrix having a relationship of the transmission source and the transmission destination.

3. The flow rule generation device as claimed in claim 1, wherein
the to specify a first container and a second container includes:
to generate a first list having the plurality of containers in which communication with the first container occurs as elements from the adjacency matrix;
to generate a second list having the plurality of containers in which communication with a third container occurs as elements from the adjacency matrix, the third container being different from the first container among the plurality of containers; and
to specify a container corresponding to an element included in the second list and not included in the first list as the second container.

4. The flow rule generation device as claimed in claim 3, wherein
the to add a rule includes to add the rule that sets the first container as the transmission destination and the second container as the transmission source to the information when a number of elements commonly included in the first list and the second list is equal to or more than a threshold value.

5. The flow rule generation device as claimed in claim 1, wherein
each of the plurality of containers achieves a service.

6. The flow rule generation device as claimed in claim 1, wherein
the processor is further configured to specify the rule corresponding to the transmission source and the transmission destination of a received packet by referring to a storage storing the information, and perform a process indicated by the specified rule on the received packet.

7. A flow rule generation method for causing a computer to execute a process, the process comprising:
generating an adjacency matrix indicating containers having a relationship of a transmission source and a transmission destination of a packet among a plurality of containers;
specifying, from the adjacency matrix, a first container and a second container in which communication is expected to occur, among two of the containers in the adjacency matrix indicating that no communication in both directions exists; and
adding a rule that sets the first container as the transmission destination and the second container as the transmission source to information including another rule indicating a process to be performed on the packet according to the transmission source and the transmission destination of the packet.

8. A non-transitory computer-readable medium having stored therein a program for causing a computer to execute a process, the process comprising:
generating an adjacency matrix indicating containers having a relationship of a transmission source and a transmission destination of a packet among a plurality of containers;
specifying, from the adjacency matrix, a first container and a second container in which communication is expected to occur, among two of the containers in the adjacency matrix indicating that no communication in both directions exists; and
adding a rule that sets the first container as the transmission destination and the second container as the transmission source to information including another rule indicating a process to be performed on the packet according to the transmission source and the transmission destination of the packet.
